(19) United States
(12) Patent Application Publication
(10) Pub. No.: US 2009/0143512 A1
(43) Pub. Date: Jun. 4, 2009

(54) Polycarbonate Resin Composition and Molded Product Produced from the Same

(76) Inventors: Tatsuya Masuki, Kanagawa-ken (JP); Yutaka Shiraishi, Kanagawa-ken (JP); Shigeru Muramatsu, Kanagawa-ken (JP)

Correspondence Address: NIXON & VANDERHYE, PC, 901 NORTH GLEBE ROAD, 11TH FLOOR, ARLINGTON, VA, 22203, US

(21) Appl. No.: 11/884,228

(22) PCT Filed: Feb. 7, 2006
(86) PCT No.: PCT/JP2006/002063

§ 371 Date: Apr. 10, 2008

(30) Foreign Application Priority Data
Feb. 15, 2005 (JP) 2005-037216

(51) Int. Cl. C08K 5/52; C08K 5/521; C08L 25/12; C08L 57/08; C08K 3/34

(52) U.S. Cl. 524/127; 524/141; 524/145; 524/535; 524/502; 524/451

(57) ABSTRACT

The present invention relates to a polycarbonate resin composition having an excellent weld strength. The polycarbonate resin composition comprises:

100 parts by weight of a mixture comprising (a) 60 to 95 parts by weight of an aromatic polycarbonate resin, (b) 4 to 39 parts by weight of a styrene/(meth)acrylonitrile-based copolymer produced by polymerizing at least a styrene-based monomer and a (meth)acrylonitrile-based monomer with each other in the presence of a rubber, and (b′) 1 to 36 parts by weight of a styrene/(meth)acrylonitrile-based copolymer produced by polymerizing at least a styrene-based monomer and a (meth)acrylonitrile-based monomer with each other in the absence of the rubber;

0 to 40 parts by weight of a phosphorus-based flame retardant (c);

0 to 5 parts by weight of a fluorinated polyolefin (d) and

0 to 50 parts by weight of an inorganic filler (e), which (c), (d) and (e) are blended to the 100 parts by weight of the mixture in respective amount,

the polycarbonate resin composition satisfying the following relational formula (1):

Sg/(Sd/B^{2/3})≧0.5 (1)

wherein B is a weight ratio (% by weight) of a sum of the components (b) and (b′) to a sum of the components (a), (b) and (b′) ((b+b′)/(a+b+b′)); Sd is an average occupation area (μm²) of a styrene/(meth)acrylonitrile-based copolymer domain (hereinafter referred to merely as an “AS domain”) dispersed in a polycarbonate resin matrix; and Sg is an average occupation area (μm²) of rubber particles dispersed in the AS domain in which Sd and Sg are values measured by subjecting an electron micrograph of the composition to image processing.

### TECHNICAL FIELD

The present invention relates to a polycarbonate resin composition, and more particularly to a polycarbonate resin composition exhibiting an improved weld strength, and a molded product obtained from the composition.

### BACKGROUND ART

Conventionally, polycarbonate resins have been used as raw materials in extensive industrial application fields such as automobiles, OA equipments and electric and electronic equipments because of excellent mechanical properties thereof. However, the polycarbonate resins have drawbacks such as high melt viscosity, poor fluidity and large thickness-dependency of impact strength. In order to ensure a good fluidity of the polycarbonate resins, there have been used the method of using polycarbonates having a low molecular weight, the method of blending various fluidity modifiers in the polycarbonate resins, etc. In any of these methods, although the effect of improving a fluidity of the resins is attained, there still occur problems such as sacrifice of impact strength inherent to the polycarbonates, and poor chemical resistance. Under these circumstances, for example, styrene-based resins such as ABS resins (acrylonitrile-butadiene-styrene copolymers) are blended in the polycarbonates in order to overcome the above problems.

Thermoplastic resin compositions composing a polycarbonate and a styrene-based resin have been recently used for production of large molded products in the application fields such as automobiles and OA equipments, and for small molded products in the application fields such as potable terminal equipments. These products have been required year by year to have a reduced wall thickness for the purpose of reduction in weight, enhancement in performance, etc. For this reason, there have been favorably used those resins having a good fluidity as well as designs of molding apparatuses of a multi-gate type. In particular, when using a multi-gate type molding apparatus, the resultant molded products have portions where the molten resins are merged together upon molding, i.e., welds. However, the thermoplastic resin compositions comprising the polycarbonate and the styrene-based resin have such a problem that the strength at the weld portions (hereinafter occasionally referred to merely as the “weld strength”), in particular, the weld strength upon retention, tends to be considerably deteriorated.

For the purpose of improving the weld strength of molded products obtained from resin compositions composed of polycarbonate and ABS resin, in Patent Document 1, there is described the method of using a polycarbonate having a specific end group. However, in Patent Document 1, there is no description concerning the relationship between a monomer composition of the ABS resin or a morphology of the resin composition and the weld strength. In addition, even the resin compositions comprising the polycarbonate having a specific end group and the ABS resin may not be improved in weld strength at all in some cases.

In Patent Document 2, there is described the method of using a polycarbonate having a specific viscoelasticity for producing a thermoplastic resin composition comprising a polycarbonate and a styrene-based resin which is excellent in weld strength, rib strength and transfer property. However, in Patent Document 2, there is no description concerning the specific relationship between a monomer composition of the ABS resin or a morphology of the resin composition and the weld strength similarly to the above Patent Document 1.

Meanwhile, in Patent Document 3, it is described that the combination of small rubber particles having a weight-average particle diameter of not less than 0.1 μm and less than 0.3 μm and large rubber particles having a weight-average particle diameter of from 0.3 to 2 μm is useful as a rubber-reinforced vinyl-based resin used in a composition comprising the rubber-reinforced vinyl-based resin, PC and a scale-like filler. However, in Patent Document 3, there is no description concerning the relationship between a monomer composition or a morphology of the resin composition and a weld strength thereof. Further, in Patent Document 3, there is described neither the method of measuring the average particle diameter nor the definition of the weight-average particle diameter notwithstanding the size of the particles used therein is defined by such a weight-average particle diameter. Therefore, it is not clear at all that the rubber proposed in the invention described in Patent Document 3 has any specific particle diameter.

Patent Document 1: Japanese Patent Publication (KOKOKU) No. Patent Document 2: Japanese Patent Application Laid-open (KOKAI) No. 2003-20395

### Patent Document 3: Japanese Patent No. 3384902

### DISCLOSURE OF THE INVENTION

### Problem to be Solved by the Invention

An object of the present invention is to provide a polycarbonate resin composition having an excellent weld strength and a molded product obtained therefrom, in particular, provide a composition capable of solving such a problem that when ABS resin is used together with As resin (acrylonitrile-styrene copolymer, etc.) as a styrene-based resin to be blended with the polycarbonate, the resultant composition is deteriorated in weld strength although a fluidity thereof is enhanced.

### Means for Solving Problem

The present invention has been made to solve the above conventional problems. Namely, to accomplish the aims, in an aspect of the present invention, there are provided a polycarbonate resin composition comprising:

100 parts by weight of a mixture comprising (a) 60 to 95 parts by weight of an aromatic polycarbonate resin, (b) 4 to 39 parts by weight of a styrene/(meth)acrylonitrile-based copolymer produced by polymerizing at least a styrene-based monomer and a (meth)acrylonitrile-based monomer with each other in the presence of a rubber, and (b′) 1 to 36 parts by weight of a styrene/(meth)acrylonitrile-based copolymer produced by polymerizing at least a styrene-based monomer and a (meth)acrylonitrile-based monomer with each other in the absence of the rubber;

0 to 40 parts by weight of a phosphorus-based flame retardant (c);

0 to 5 parts by weight of a fluorinated polyolefin (d) and

0 to 50 parts by weight of an inorganic filler (e), which (c), (d) and (e) are blended to the 100 parts by weight of the mixture in respective amount,

the polycarbonate resin composition satisfying the following relational formula (1):

Sg/(Sd/B^{2/3})≧0.5 (1)

wherein B is a weight ratio (% by weight) of a sum of the components (b) and (b′) to a sum of the components (a), (b) and (b′) ((b+b′)/(a+b+b′)); Sd is an average occupation area (μm²) of a styrene/(meth)acrylonitrile-based copolymer domain (hereinafter referred to merely as an “AS domain”) dispersed in a polycarbonate resin matrix; and Sg is an average occupation area (μm²) of rubber particles dispersed in the AS domain in which Sd and Sg are values measured by subjecting an electron micrograph of the composition to image processing.

### EFFECT OF THE INVENTION

The polycarbonate resin composition of the present invention is excellent in fluidity and weld strength, and useful for production of large molded products used in the application fields such as electric and electronic equipments and precision machines as well as thin-wall molded products.

### BRIEF DESCRIPTION OF DRAWING

FIG. 1 is a micrograph of an ultrathin piece of pellets obtained in Example 1.

FIG. 2 is an image for measuring Sd which is prepared from FIG. 1.

FIG. 3 is an image for measuring Sg which is prepared from FIG. 1.

FIG. 4 is a micrograph of an ultrathin piece of pellets obtained in Comparative Example 1.

FIG. 5 is an image for measuring Sd which is prepared from FIG. 4.

FIG. 6 is an image for measuring Sg which is prepared from FIG. 4.

### PREFERRED EMBODIMENTS FOR CARRYING OUT THE INVENTION

The present invention is described in detail below.

### (a) Aromatic Polycarbonate Resin:

Examples of the aromatic polycarbonate resin (a) used in the present invention may include branched or unbranched thermoplastic polymers or copolymers which are produced by reacting an aromatic dihydroxy compound or a mixture of the aromatic dihydroxy compound and a small amount of a polyhydroxy compound with phosgene or a carbonic diester. The method for producing the aromatic polycarbonate resin is not particularly limited, and the aromatic polycarbonate resin may be produced by conventionally known methods such as a phosgene method (interfacial polymerization method) and a melting method (transesterification method). Alternatively, the aromatic polycarbonate resin may also be produced by controlling an amount of OH end groups of the resin produced by the melting method.

The amount of the aromatic polycarbonate resin (a) blended is 60 to 95 parts by weight and preferably 65 to 90 parts by weight on the basis of 100 parts by weight of a sum of the aromatic polycarbonate resin (a), a styrene/(meth)acrylonitrile-based copolymer (b) produced by polymerizing at least a styrene-based monomer and a (meth)acrylonitrile-based monomer with each other in the presence of a rubber, and a styrene/(meth)acrylonitrile-based copolymer (b′) produced by polymerizing at least a styrene-based monomer and a (meth)acrylonitrile-based monomer with each other in the absence of the rubber. When the amount of the aromatic polycarbonate resin blended is more than the above-specified upper limit, the resultant composition tends to be deteriorated in fluidity, whereas when the amount of the aromatic polycarbonate resin blended is less than the above-specified lower limit, the resultant composition tends to be deteriorated-in heat resistance.

Examples of the aromatic dihydroxy compound may include 2,2-bis(4-hydroxyphenyl)propane (bisphenol A), tetramethyl bisphenol A, bis(4-hydroxyphenyl)-p-diisopropyl benzene, hydroquinone, resorcinol, 4,4-dihydroxydiphenyl, etc. Among these aromatic dihydroxy compounds, preferred is bisphenol A. In addition, as the aromatic dihydroxy compound, there may also be used those compounds to which one or more tetraalkyl phosphonium sulfonate groups are bonded.

The branched aromatic polycarbonate resin may be obtained by replacing a part of the above aromatic dihydroxy compound with a polyhydroxy compound such as fluoroglucin, 4,6-dimethyl-2,4,6-tri(4-hydroxyphenyl)heptene-2, 4,6-dimethyl-2,4,6-tri(4-hydroxyphenyl)heptane, 2,6-dimethyl-2,4,6-tri(4-hydroxyphenyl)heptene-3, 1,3,5-tri(4-hydroxyphenyl)benzene and 1,1,1-tri(4-hydroxyphenyl)ethane, or 3,3-bis(4-hydroxyaryl)oxyindole (isatin bisphenol), 5-chloroisatin, 5,7-dichloroisatin, 5-bromoisatin, etc. The amount of the polyhydroxy compound, etc., used is 0.01 to 10 mol % and preferably 0.1 to 2 mol % on the basis of the dihydroxy compound.

In order to control a molecular weight of the aromatic polycarbonate resin, there may be used monovalent aromatic hydroxy compounds. Examples of the monovalent aromatic hydroxy compounds may include aromatic monohydroxy compounds such as m- and p-methyl phenol, m- and p-propyl phenol, p-tert-butyl phenol and p-long chain alkyl-substituted phenol, etc.

As the aromatic polycarbonate resin, there may be preferably used polycarbonate resins derived from 2,2-bis(4-hydroxyphenyl)propane, or polycarbonate copolymers derived from 2,2-bis(4-hydroxyphenyl)propane and the other aromatic dihydroxy compound. The aromatic polycarbonate resin may also be obtained by copolymerizing these compounds with a polymer or oligomer having a siloxane structure. These aromatic polycarbonate resins may also be used in the form of a mixture of any two or more thereof.

As to the molecular weight of the aromatic polycarbonate resin, the viscosity-average molecular weight thereof in terms of a solution viscosity as measured at 25° C. in methylene chloride as a solvent, is 16,000 to 30,000 and preferably 18,000 to 28,000. When the viscosity-average molecular weight of the aromatic polycarbonate resin is more than the above-specified upper limit, the resultant composition tends to be deteriorated in fluidity, whereas when the viscosity-average molecular weight thereof is less than the above-specified lower limit, the resultant composition tends to be insufficient in impact resistance. (b) Styrene/(meth)acrylonitrile-based copolymer:

The styrene/(meth)acrylonitrile-based copolymer (b) used in the present invention is produced by polymerizing at least a styrene-based monomer and a (meth)acrylonitrile-based monomer, if required, further copolymerizing these monomers with the other monomer copolymerizable with the styrene-based monomer and the (meth)acrylonitrile-based monomer, in the presence of a rubber. The styrene/(meth)acrylonitrile-based copolymer used in the present invention is not particularly limited to those graft copolymers obtained by graft-copolymerizing all of the above two or more kinds of monomers to the rubber. Rather, the styrene/(meth)acrylonitrile-based copolymer is usually in the form of a mixture containing not only the graft copolymer but also such copolymers obtained by copolymerizing the above two or more kinds of monomers solely with each other.

The styrene/(meth)acrylonitrile-based copolymer (b) used in the present invention may include, for example, ABS resins, AES resins, AAS resins, etc., according to kinds of rubber and monomers constituting the copolymer. Examples of the method for producing these copolymers may include known methods such as an emulsion polymerization method, a solution polymerization method, a suspension polymerization method and a bulk polymerization method.

The amount of the styrene/(meth)acrylonitrile-based copolymer (b) blended is 4 to 39 parts by weight and preferably 10 to 35 parts by weight on the basis of 100 parts by weight of a sum of the aromatic polycarbonate resin (a), the styrene/(meth)acrylonitrile-based copolymer (b) produced by polymerizing at least a styrene-based monomer and a (meth)acrylonitrile-based monomer with each other in the presence of a rubber, and the styrene/(meth)acrylonitrile-based copolymer (b′) produced by polymerizing at least a styrene-based monomer and a (meth)acrylonitrile-based monomer with each other in the absence of the rubber. When the amount of the styrene/(meth)acrylonitrile-based copolymer (b) blended is more than the above-specified upper limit, the resultant composition tends to be deteriorated in impact resistance, whereas when the amount of the styrene/(meth)acrylonitrile-based copolymer (b) blended is less than the above-specified lower limit, the resultant composition tends to be deteriorated in fluidity.

(b′) Styrene/(meth)acrylonitrile-based Copolymer:

The styrene/(meth)acrylonitrile-based copolymer (b) produced by polymerizing at least the styrene-based monomer and the (meth)acrylonitrile-based monomer with each other in the presence of the rubber, is not used alone but necessarily used in combination with the styrene/(meth)acrylonitrile-based copolymer (b′) produced by polymerizing at least the styrene-based monomer and the (meth)acrylonitrile-based monomer, if required, further copolymerizing these monomers with the other monomer copolymerizable with the styrene-based monomer and the (meth)acrylonitrile-based monomer, for example, AS resins, etc., in the absence of the rubber, when blended with the aromatic polycarbonate resin (a). Both the components (b) and (b′) used in combination with each other may be made of either the same monomer units or different kinds of monomer units.

The amount of the styrene/(meth)acrylonitrile-based copolymer (b′) blended is 1 to 36 parts by weight and preferably 3 to 25 parts by weight on the basis of 100 parts by weight of a sum of the aromatic polycarbonate resin (a), the styrene/(meth)acrylonitrile-based copolymer (b) produced by polymerizing at least a styrene-based monomer and a (meth)acrylonitrile-based monomer with each other in the presence of the rubber, and the styrene/(meth)acrylonitrile-based copolymer (b′) produced by polymerizing at least a styrene-based monomer and a (meth)acrylonitrile-based monomer with each other in the absence of the rubber. When the amount of the styrene/(meth)acrylonitrile-based copolymer (b′) blended is more than the above-specified upper limit, the resultant composition tends to be deteriorated in impact resistance, whereas when the amount of the styrene/(meth)acrylonitrile-based copolymer (b′) blended is less than the above-specified lower limit, the resultant composition tends to be deteriorated in fluidity.

Examples of the styrene-based monomer may include styrene, α-methyl styrene, p-methyl styrene, etc. Among these styrene-based monomers, preferred is styrene. Examples of the (meth)acrylonitrile-based monomer may include acrylonitrile, methacrylonitrile, etc.

Examples of the monomers capable of being copolymerized with the styrene-based monomer and the (meth)acrylonitrile-based monomer may include alkyl (meth)acrylates such as methyl acrylate, ethyl acrylate, propyl acrylate, methyl methacrylate and ethyl methacrylate; maleimide; N-phenyl maleimide; etc. Among these monomers, preferred are alkyl (meth)acrylates.

The rubber is preferably selected from those rubbers having a glass transition temperature of not more than 10° C. Specific examples of the rubber may include diene-based rubbers, acrylic rubbers, ethylene/propylene rubbers, silicone rubbers, etc. Among these rubbers, from the standpoint of a good balance between properties and costs, preferred are diene-based rubbers, acrylic rubbers, etc.

Examples of the diene-based rubbers may include polybutadiene, butadiene/styrene copolymers, polyisoprene, butadiene/lower-alkyl (meth)acrylate copolymers, butadiene/styrene/lower-alkyl (meth)acrylate copolymers, etc. Examples of the lower-alkyl (meth)acrylate may include methyl acrylate, ethyl acrylate, methyl methacrylate, ethyl methacrylate, etc. The content of the lower-alkyl (meth)acrylate in the butadiene/lower-alkyl (meth)acrylate copolymers and the butadiene/styrene/lower-alkyl (meth)acrylate copolymers is preferably not more than 30% by weight on the basis of the weight of the respective rubbers.

Examples of the acrylic rubbers may include alkyl acrylate rubbers, etc. The alkyl group contained in the alkyl acrylate rubbers preferably has 1 to 8 carbon atoms. Specific examples of the alkyl acrylate rubbers may include ethyl acrylate, butyl acrylate, ethylhexyl acrylate, etc. The alkyl acrylate rubbers may optionally contain a crosslinkable ethylenically unsaturated monomer. Examples of the crosslinking agent may include alkylene diol di(meth)acrylates, polyester di(meth)acrylates, divinyl benzene, trivinyl benzene, triallyl cyanurate, allyl (meth)acrylate, butadiene, isoprene, etc. Further examples of the acrylic rubbers may include core/shell type polymers having a core portion composed of a crosslinked diene-based rubber.

### (c) Phosphorus-based Flame Retardant:

The phosphorus-based flame retardant (c) used in the present invention is made of a compound containing phosphorus in a molecule thereof. The phosphorus-based flame retardant is preferably a phosphorus-based compound represented by the following general formula (1) or (2).

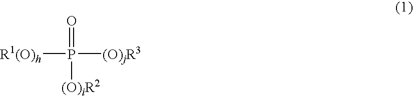

(wherein R¹, R² and R³ are respectively an alkyl group having 1 to 6 carbon atoms or an aryl group having 6 to 20 carbon atoms which may be substituted with an alkyl group; and h, i and j are respectively 0 or 1.)

The phosphorus-based compound represented by the above general formula (1) may be produced from phosphorus oxychloride, etc., by known methods. Specific examples of the phosphorus-based compound represented by the general formula (1) may include triphenyl phosphate, tricresyl phosphate, diphenyl 2-ethylcresyl phosphate, tri(isopropylphenyl) phosphate, diphenyl methyl phosphonate, diethyl phenyl phosphonate, diphenyl cresyl phosphate, tributyl phosphate, etc.

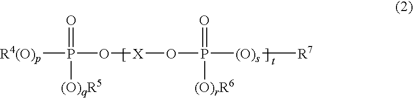

(wherein R⁴, R⁵, R⁶ and R⁷ are respectively an alkyl group having 1 to 6 carbon atoms or an aryl group having 6 to 20 carbon atoms which may be substituted with an alkyl group; p, q, r and s are respectively 0 or 1; t is an integer of 1 to 5; and X is an arylene group.)

The phosphorus-based compound represented by the above general formula (2) is a condensed phosphoric ester represented by the above general formula (2) in which t is 1 to 5. When using a mixture of the condensed phosphoric esters which are different in the number of t from each other, an average value of plural t's is determined as t of the mixture. In the general formula (2), X represents an arylene group. Examples of the arylene group may include divalent groups derived from dihydroxy compounds such as resorcinol, hydroquinone and bisphenol A. Examples of the phosphorus-based compound represented by the general formula (2) in which the arylene group X is derived from resorcinol as the dihydroxy compound may include phenyl-resorcin-polyphosphate, cresyl-resorcin-polyphosphate, phenyl-cresyl-resorcin-polyphosphate, xylyl-resorcin-polyphosphate, phenyl-p-t-butylphenyl-resorcin-polyphosphate, phenyl-isopropyl-phenyl-resorcin-polyphosphate, cresyl-xylyl-resorcin-polyphosphate, phenyl-isopropyl-phenyl-diisopropylphenyl-resorcin-polyphosphate, etc.

The phosphorus-based flame retardant (c) used in the present invention may be made of a phosphazen compound. The phosphazen compound may be at least one compound selected from the group consisting of cyclic phenoxy phosphazen compounds, chain-like phenoxy phosphazen compounds and crosslinked phenoxy phosphazen compounds.

The amount of the phosphorus-based flame retardant blended is 0 to 40 parts by weight, preferably 3 to 30 parts by weight and more preferably 5 to 25 parts by weight on the basis of 100 parts by weight of a sum of the aromatic polycarbonate resin (a), the styrene/(meth)acrylonitrile-based copolymer (b) produced by polymerizing at least a styrene-based monomer and a (meth)acrylonitrile-based monomer with each other in the presence of the rubber, and the styrene/(meth)acrylonitrile-based copolymer (b′) produced by polymerizing at least a styrene-based monomer and a (meth)acrylonitrile-based monomer with each other in the absence of the rubber. When the amount of the phosphorus-based flame retardant blended is more than the above specified upper limit, the resultant composition tends to be deteriorated in mechanical properties.

### (d) Fluorinated Polyolefin:

Examples of the fluorinated polyolefin used in the present invention may include fluorinated polyethylenes. Among these fluorinated polyethylenes, preferred is polytetrafluoroethylene having a fibril-forming property which tends to be readily dispersed in the polymer and cause molecules of the polymer to be bonded to each other therethrough to form a fibrous material. The polytetrafluoroethylene having a fibril-forming property is classified into three types according to ASTM standard. Examples of commercially available products of the polytetrafluoroethylene having a fibril-forming property may include “Teflon (registered trademark) 6J” and “Teflon (registered trademark) 30J” both produced by Mitsui-DuPont Fluorochemical Co., Ltd., and “Polyflon” produced by Daikin Kogyo Co., Ltd.

The amount of the fluorinated polyolefin blended is 0 to 5 parts by weight, preferably 0.02 to 4 parts by weight and more preferably 0.03 to 3 parts by weight on the basis of 100 parts by weight of a sum of the aromatic polycarbonate resin (a), the styrene/(meth)acrylonitrile-based copolymer (b) produced by polymerizing at least a styrene-based monomer and a (meth)acrylonitrile-based monomer with each other in the presence of the rubber, and the styrene/(meth)acrylonitrile-based copolymer (b′) produced by polymerizing at least a styrene-based monomer and a (meth)acrylonitrile-based monomer with each other in the absence of the rubber. When the amount of the fluorinated polyolefin blended is more than the above specified upper limit, the molded product formed from the resultant composition tends to be deteriorated in appearance of molded product.

### (e) Inorganic Filler:

The inorganic filler (e) used in the present invention is not particularly limited, and there may be used all of ordinarily used inorganic fillers. Specific examples of the inorganic filler may include glass fibers, glass flakes, glass beads, milled glass, hollow glass, talc, clay, mica, carbon fibers, wollastonite, potassium titanate whiskers, titanium oxide whiskers, zinc oxide whiskers, etc. Among these inorganic fillers, from the standpoint of a good appearance of the obtained molded product, preferred are milled glass, talc, clay, wollastonite, etc., and more preferred is surface-untreated talc having a number-average particle diameter of not more than 9.0 μm as measured by a laser diffraction method in which the contents of Fe components and Al components therein are both not more than 0.5% by weight in terms of Fe₂O₃ and A1₂O₃, respectively.

The amount of the inorganic filler blended is 0 to 50 parts by weight, preferably 1 to 40 parts by weight and more preferably 3 to 30 parts by weight on the basis of 100 parts by weight of a sum of the aromatic polycarbonate resin (a), the styrene/(meth)acrylonitrile-based copolymer (b) produced by polymerizing at least a styrene-based monomer and a (meth)acrylonitrile-based monomer with each other in the presence of the rubber, and the styrene/(meth)acrylonitrile-based copolymer (b′) produced by polymerizing at least a styrene-based monomer and a (meth)acrylonitrile-based monomer with each other in the absence of the rubber. When the amount of the inorganic filler blended is more than the above specified upper limit, the molded product formed from the resultant composition tends to be deteriorated in appearance and impact strength.

### Average Occupation Areas Sd and Sg of AS Domain and Rubber Particles as Measured by Subjecting a Micrograph of the Composition to Image Processing:

The resin composition or the molded product obtained therefrom according to the present invention usually has the morphology in which a large number of non-continuous phase portions each composed of a mixture of the component (b), i.e., the styrene/(meth)acrylonitrile-based copolymer produced by polymerizing at least a styrene-based monomer and a (meth)acrylonitrile-based monomer with each other in the presence of the rubber, and the component (b′), i.e., the styrene/(meth)acrylonitrile-based copolymer produced by polymerizing at least a styrene-based monomer and a (meth)acrylonitrile-based monomer with each other in the absence of the rubber (in the present specification, hereinafter referred to the “AS domain” despite whether the portions are derived from the component (b) or the component (b′); the As domain may or may not contain the rubber particles), are dispersed in a continuous phase composed of the component (a), i.e., the aromatic polycarbonate resin (in the present specification, hereinafter referred to as a “matrix”). This structure may be readily confirmed by an electron microscope using an appropriate dyeing technique such as two-stage dyeing method using osmium tetraoxide and ruthenium tetraoxide.

More specifically, when observing the composition or molded product of the present invention after being subjected to the two-stage dyeing, there is recognized such a structure composed of three separate portions including (A) a gray-color matrix, (B) a light-color AS domain and (C) a dark-color non-continuous phase inside of the light color AS domain. Among these portions, the dark-color non-continuous phase is an osmium tetraoxide-dyed product of the rubber to which both of the above monomers may or may not be graft-polymerized.

As a result of the present inventors' earnest study on the morphology of the composition, in particular, the interrelation between the average occupation areas of the light-color AS. domain (B) and the dark-color non-continuous phase (rubber particles) and the weld strength of the composition, the specific conclusion has been reached. That is, when the weight ratio of a sum of the components (b) and (b′) to a sum of the components (a), (b) and (b′) ((b+b′)/(a+b+b′)) is expressed by B (% by weight), it is required that the value of Sg/(Sd/B²/³) as a function of Sd which is an average occupation area (μm²) of the AS domain dispersed in the polycarbonate resin matrix and Sd which is an average occupation area (μm²) of the rubber particles dispersed in the AS domain wherein the Sg and Sd are values measured by subjecting an electron micrograph of the thus dyed composition to image processing, is not less than 0.5, i.e., the composition of the present invention is required to satisfy the following relational formula (1):

Sg/(Sd/B^{2/3})≧0.5 (1)

The value of the above relational formula (1) is preferably not less than 0.55 and more preferably not less than 0.6. In the above relational formula (1), the value of Sd varies, for example, depending upon ratio of respective components and production conditions of the resin composition, kinds and production methods of the components (b) and (b′), etc. The larger value of Sg/(Sd/B²/³) means the larger ratio of the rubber particle diameter Sg to the AS domain diameter Sd. The present inventors have found that when the relational formula (1) is satisfied, the resultant composition can be improved in weld strength as aimed by the present invention. Among these factors for determining the value of Sg/(Sd/B^{2/3}), the present inventors have noticed the compositional ratio of monomer units constituting each of the two kinds of styrene/(meth)acrylonitrile-based copolymers as the components (b) and (b′) and studied the interrelation of these ratios with the value of Sg/(Sd/B^{2/3}). As a result, it has been found that the compositional ratio of the monomer units constituting the component (b) is fully different from the compositional ratio of the monomer units constituting the component (b′), i.e., when the following relational formula (3) is satisfied, the obtained resin composition and the molded product thereof can exhibit a desired weld strength.

|Ab−Ab′|≧3 (3)

The value of the above relational formula (3) is preferably not less than 4 and more preferably not less than 5. Here, Ab (wt %) represents a weight ratio of a (meth)acrylonitrile-based monomer unit to a sum of a styrene-based monomer unit and the (meth)acrylonitrile-based monomer unit in the component (b), whereas Ab′ (wt %) represents a weight ratio of a (meth)acrylonitrile-based monomer unit to a sum of a styrene-based monomer unit and the (meth)acrylonitrile-based monomer unit in the component (b′).

When using the components (b) and (b′) satisfying the conditions of the above relational formula (3) in combination with each other, the As domain derived from the component (b) is less compatilizable with the As domain derived from the component (b′), resulting in tendency that a large AS domain is hardly formed. As a result, the above relational formula (1) can be readily satisfied.

For example, in general, if the weight ratio Ab (wt %) of the (meth)acrylonitrile-based monomer unit to a sum of the styrene-based monomer unit and the (meth)acrylonitrile-based monomer unit in the component (b) is 26% by weight, the weight ratio Ab′ (wt %) of the (meth)acrylonitrile-based monomer unit to a sum of the styrene-based monomer unit and the (meth)acrylonitrile-based monomer unit in the component (b′) used together with the component (b) is substantially identical to the weight ratio Ab, i.e., the Ab′ is about 26% by weight. However, in the present invention, unlike the above general case, the combination of the components (b) and (b′) which are fully different in compositional ratio of monomer units from each other is used to enhance a dispersibility of the AS domain, so that the obtained composition can exhibit a high weld strength. Further, even the resin composition containing an inorganic filler which is usually considered to undergo deterioration in strength. can also maintain a high weld strength.

In the present invention, the procedures of measuring the average occupation area Sd of the AS domain dispersed in the polycarbonate resin matrix and the average occupation area Sg of the rubber particles dispersed in the AS domain by subjecting the electron micrograph of the composition dyed by the above method to image processing, are as follows.

(1) The electron micrograph (analogue information) is digitized to obtain a monochrome image information.

(2) Only a specific information is fetched from the monochrome image information to obtain an image information for measurement. The specific information to be fetched is such an information relating to a shape of contour line and a dimension of the light-color AS domain (B) or the dark-color rubber particles which are capable of measuring individual occupation areas of the AS domains or the rubber particles.

(3) The individual occupation areas of the AS domains or the rubber particles are measured from the image information for measurement to calculate an average occupation area (Sd) or (Sg) as a number average value thereof.

Meanwhile, in the above measuring procedures (1) to (3), the following necessary coordination procedures (4) and (5) are conducted.

(4) The domains or particles having a measured occupation area of not more than 0.01 μm² are excluded from the calculation of the number-average value.

(5) In the procedure for measuring Sg, the area of the light-color AS domain (B) which is present inside of the contour line of the dark-color rubber particles (C) is involved in the occupation area of the rubber particles.

### Process for Producing the Polycarbonate Resin Composition:

The process for producing the polycarbonate resin composition of the present invention is not particularly limited as long as the average occupation areas Sd and Sg of the AS domain dispersed in the composition and the rubber particles dispersed in the AS domain as measured by subjecting the micrograph of the composition to image processing fulfil the above specified requirements. For example, there may be used the method of melting and kneading the aromatic polycarbonate resin, the two kinds of styrene/(meth)acrylonitrile-based copolymers (b) and (b′), the phosphorus-based flame retardant and polytetrafluoroethylene at one time, the method of previously kneading the aromatic polycarbonate resin, the two kinds of styrene/(meth)acrylonitrile-based copolymers and polytetrafluoroethylene together, and then kneading the mixture while feeding the flame retardant thereto in the course of an extruder, etc.

The average occupation area Sg may also be controlled by appropriately selecting the two kinds of styrene/(meth)acrylonitrile-based copolymers (b) and (b′) to be blended in the aromatic polycarbonate resin (a) as well as the production methods thereof. The weight ratio Ab (% by weight) of the (meth)acrylonitrile-based monomer unit to a sum of the styrene-based monomer unit and the (meth)acrylonitrile-based monomer in the component (b) and the weight ratio Ab′ (% by weight) of the (meth)acrylonitrile-based monomer unit to a sum of the styrene-based monomer unit and the (meth)acrylonitrile-based monomer unit in the component (b′) preferably satisfies the following relational formula (3):

|Ab−Ab′|≧3 (3).

The value of the above relational formula (3) is more preferably not less than 4 and still more preferably not less than 5.

The polycarbonate resin composition of the present invention may also contain, if required, various additives such as stabilizers, e.g., ultraviolet absorbers and antioxidants, pigments, dyes, lubricants, mold release agents, plasticizers, antistatic agents, sliding modifiers, elastomers, compatilizers and other flame retardants. These additives may be appropriately added by conventionally known methods capable of effectively exhibiting properties thereof.

In addition to the aromatic polycarbonate resin as the component (a) and the two kinds of styrene/(meth)acrylonitrile-based copolymers as the components (b) and (b′), the polycarbonate resin composition of the present invention may also be blended with thermoplastic resins such as polyester resins, e.g., polybutylene terephthalate and polyethylene terephthalate, polyamide resins, polyphenylene ether resins and polyolefin resins. The amount of the thermoplastic resins other than the aromatic polycarbonate resin and the two kinds of styrene/(meth)acrylonitrile-based copolymers which may be blended in the composition of the present invention is preferably not more than 40% by weight and more preferably not more than 30% by weight on the basis of the weight of the thermoplastic polycarbonate resin composition.

The polycarbonate resin composition of the present invention is preferably in the form of a halogen-free polycarbonate resin composition. The components blended in the composition of the present invention are preferably respectively free from halogens or have a less halogen content from the standpoint of preventing corrosion of a molding machine and a metal mold used as well as avoiding environmental problems.

The method of molding the polycarbonate resin composition of the present invention is not particularly limited. The polycarbonate resin composition may be molded by molding or shaping methods ordinarily used for thermoplastic resins such as injection molding, blow molding, extrusion molding, press forming, sheet molding, thermoforming, rotary molding and lamination molding. Among these molding methods, preferred is an injection molding method.

### EXAMPLES

The present invention is described in more detail by the following Examples. However, these Examples are only illustrative and not intended to limit a scope of the present invention. Meanwhile,-the following raw materials were used in Examples and Comparative Examples.

(1) Polycarbonate resin-1: Poly-4,4-isopropylidenediphenylcarbonate “Iupilon S-2000” produced by Mitsubishi Engineering-Plastics Corporation (viscosity-average molecular weight: 25000; hereinafter occasionally referred to merely as “PC-1”)
(2) Polycarbonate resin-2: Poly-4,4-isopropylidenediphenylcarbonate “Iupilon S-3000” produced by Mitsubishi Engineering-Plastics Corporation (viscosity-average molecular weight: 22000; hereinafter occasionally referred to merely as “PC-2”)

(3) ABS resin: Emulsion-polymerized ABS resin; kind of rubber: polybutadiene; “DP-611” produced by Techno Polymer Co., Ltd.; AN ratio: 26%

(4) AS resin-1: AS resin “SAN-T” produced by Techno Polymer Co., Ltd.; AN ratio: 34%

(5) AS resin-2: AS resin “SAN-R” produced by Techno Polymer Co., Ltd.; AN ratio: 20%

(6) AS resin-3: AS resin “SAN-C” produced by Techno Polymer Co., Ltd.; AN ratio: 26%

(7) Flame retardant: Condensed phosphoric ester represented by the following formula (3) wherein t₂=1.08; “FP-700” produced by Asahi Denka Kogyo Co., Ltd.

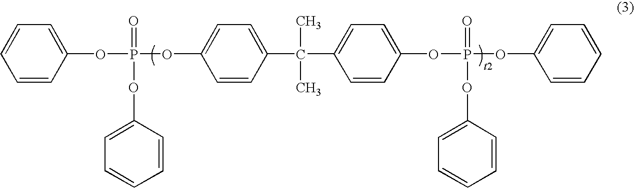

(8) Polytetrafluoroethylene (PTFE): “POLYFLON F-201L” produced by Daikin Co., Ltd.

(9) Inorganic filler: talc; number-average particle diameter: 4.9 μm; product subjected to no surface treatment; “MICRON-WHITE 5000S” produced by Hayashi Kasei Co., Ltd.

Meanwhile, various properties of a test piece were evaluated by the following methods.

(10) Tensile Strength:

According to ISO 527-1 and -2, the test piece of 1A type having a thickness of 4 mm was subjected to tensile test at a testing speed of 50 mm/min. Meanwhile, when molding a test piece with a weld, a metal mold having two gates on a central line of the surface thereof in the longitudinal direction of the test piece (distance between gates: 170 mm) was used to form a weld in a central portion of the test piece, and the obtained test piece was subjected to tensile test under the same conditions as used for the weld-free test piece. The measurement results are expressed as the tensile strength, weld tensile strength and weld tensile strength upon retention according to the kinds of test pieces used. Also, for the purpose of evaluating the weld strength, the percentages of the weld tensile strength and the weld tensile strength upon retention based on the tensile strength are calculated, and the calculated values are expressed as a retention rate of the respective strengths.

(11) Fluidity:

Using a bar flow metal mold (thickness: 2 mm; width: 20 mm; pin gate: 1.5 mmΦ), the length of flow (unit: mm) was measured under the conditions including a cylinder temperature of 240° C., a metal mold set temperature of 60° C., an injection pressure of 100 MPa, an injection time of 5 sec and a molding cycle of 45 sec.

(12) Observation using a transmission electron microscope:

[Ultrathin Test Piece]

A sample pellet was sliced into a piece at a central portion in its strand direction such that an end surface thereof was observed as a plane perpendicular to the strand direction. The thus obtained piece was cut by a diamond knife using an ultra-microtome “ULTRACUT UCT” manufactured by LEICA Corp., which was equipped with a sample cooling apparatus (cryo-unit) to produce an ultrathin test piece. The cutting conditions set were as follows: Sample chamber temperature: −100° C.; Thickness of the ultrathin test piece: 100 nm.

[Two-stage Dyeing]

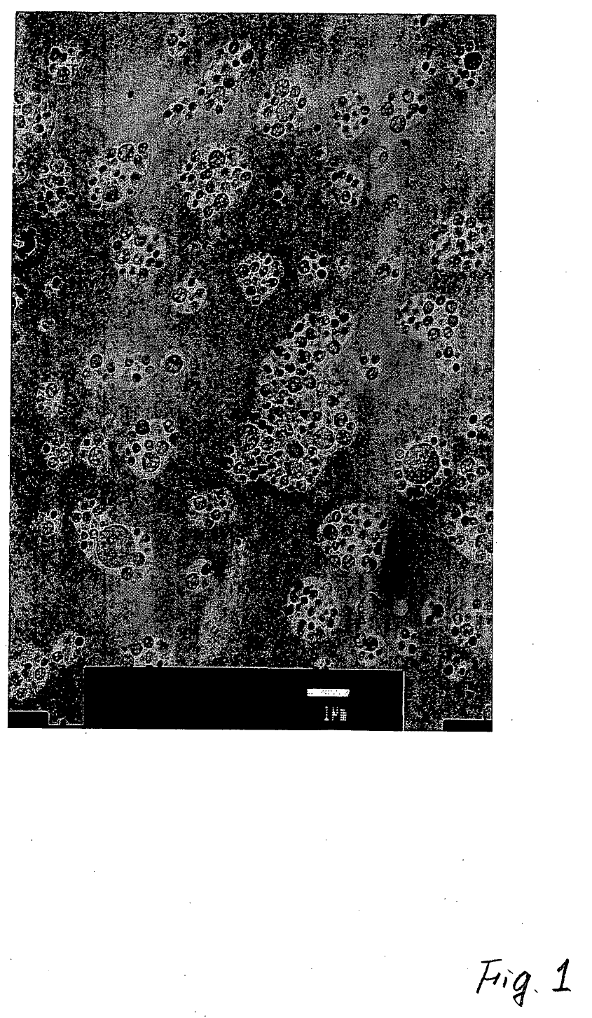

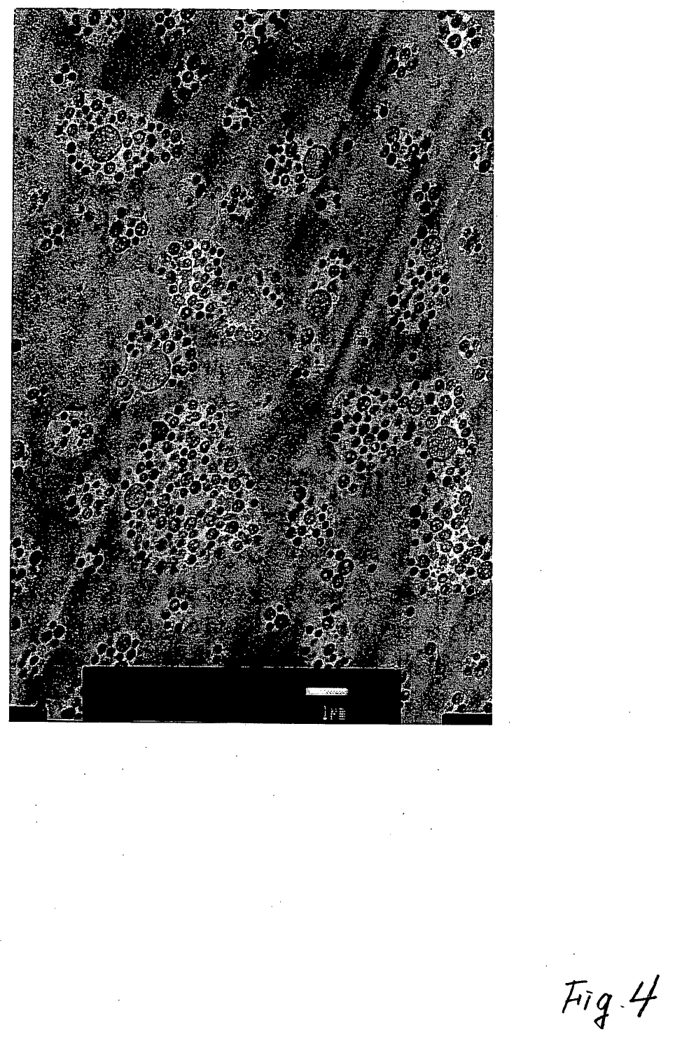

The ultrathin test piece was placed on a copper grid and then subjected to two-stage dyeing with osmium tetraoxide and ruthenium tetraoxide. As a result of the dyeing, as shown in the attached FIG. 1 or FIG. 4, the polycarbonate was observed as a gray-color matrix (A); the styrene/(meth)acrylonitrile-based copolymer was observed as a light-color domain (B); and the butadiene rubber was observed as a dark-color non-continuous phase within the light-color domain.

[Photographing of Electron Micrograph]

The dyed ultrathin test piece was observed using a transmission electron microscope “1200EXII Model” manufactured by Nippon Denshi Co., Ltd., at an acceleration voltage of 100 kV by setting a magnification thereof to x 5000 times, and then photographed upon the observation to record an image thereof on an electron-microscopic film “FG” (size: 5.9×8.2 cm) produced by Fiji Photo Film Co., Ltd. The range of the image recorded was about 11×15 μm.

[Image Processing]

The image recorded on a negative film by photographing was digitized using a film scanner “Dimage Scan Multi F-3000 Model” manufactured by Konica Minolta Photo Imaging Co., Ltd. The digitization was conducted at 564 dpi, thereby obtaining a monochrome image file having about 1240×1800 pixel.

AS Domain:

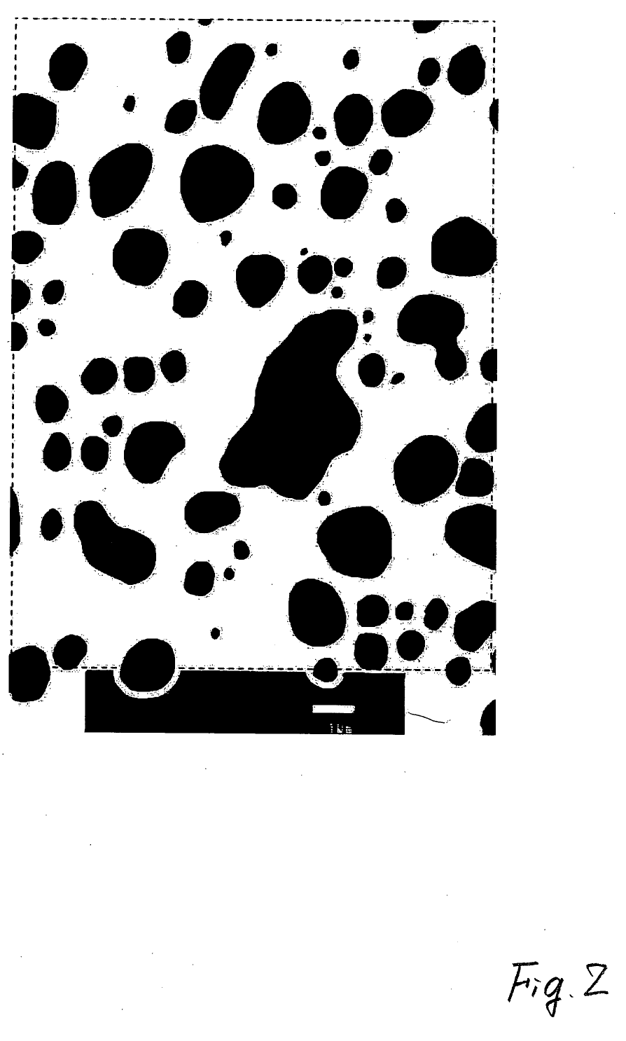

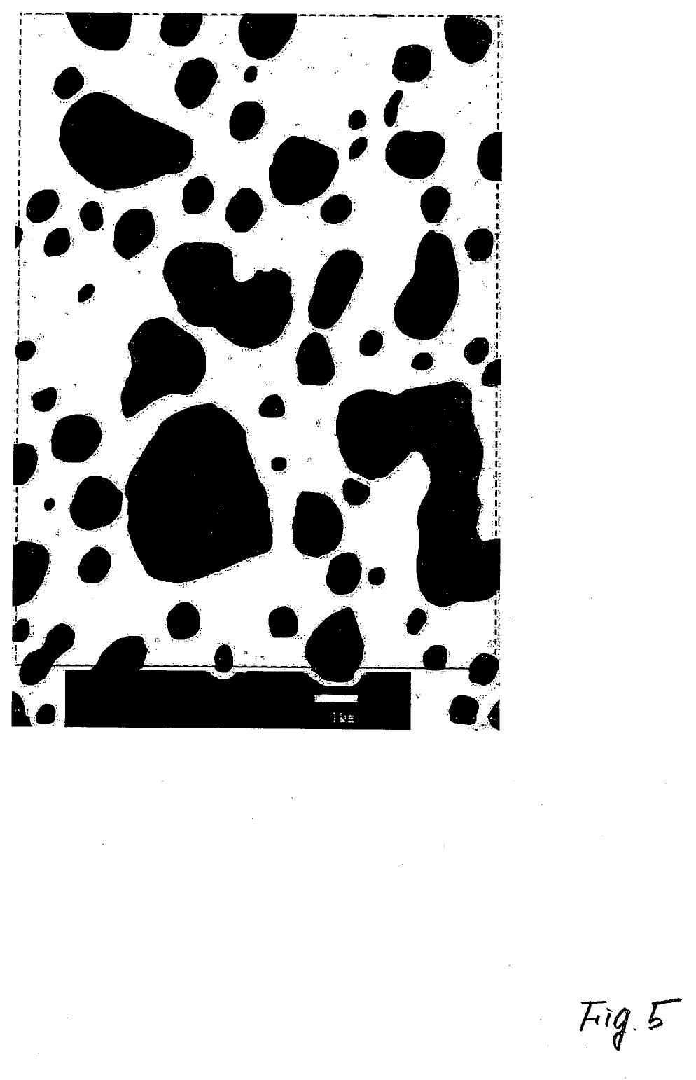

The thus obtained monochrome image file was processed using “Photo Shop” (Ver. 7) available from Adobe Inc., to extract an information of the AS domain and convert it into binary data, thereby preparing an image for measurement (refer to the attached FIG. 2 or FIG. 5). The extraction of the information of the AS domain and the conversion thereof into binary data were conducted based on the following standards. (1) The light-color domain (B) observed as a result of the above two-stage dyeing was extracted as the “AS domain”. Upon the extraction, the dark-color rubber particles (C) present inside of the light-color domain (B) were involved in the occupation area of the “AS domain”. (2) The threshold value for the conversion into binary data was set to an adequate lightness value at which the light-color “AS domain” only was selected, and neither the gray-color matrix (A) darker than the “AS domain” nor the dark-color rubber particles (C) were selected.

From the thus prepared image for measurement, the occupation area of the AS domain was measured using “ImagePro Plus” (ver. 4.0) available from Media Cybernetics Inc. Upon the measurement, the length on an image screen was corrected based on the scale recorded upon photographing the respective images. The measurement was performed within the broken line frame as shown in the figures. The thus measured occupation areas of the AS domains and the number thereof were summed to calculate a number-average value of the occupation areas of the AS domains, i.e., determine an average occupation area Sd thereof. In this case, the domains having a measured occupation area of not more than 0.01 μm² were excluded from the calculation of the number-average value.

### Rubber Particles:

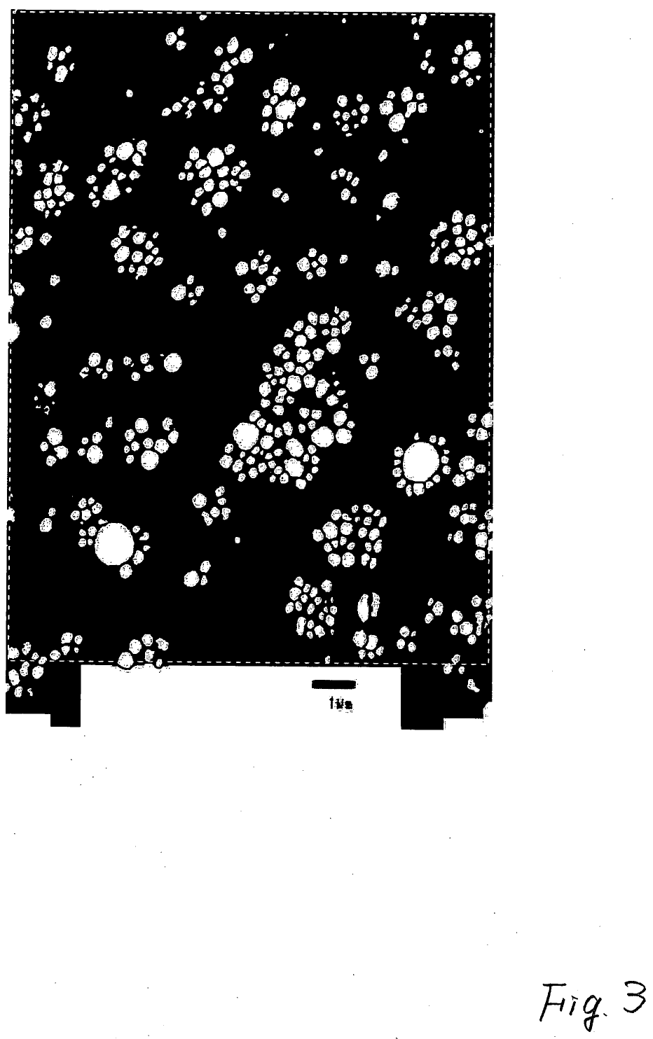

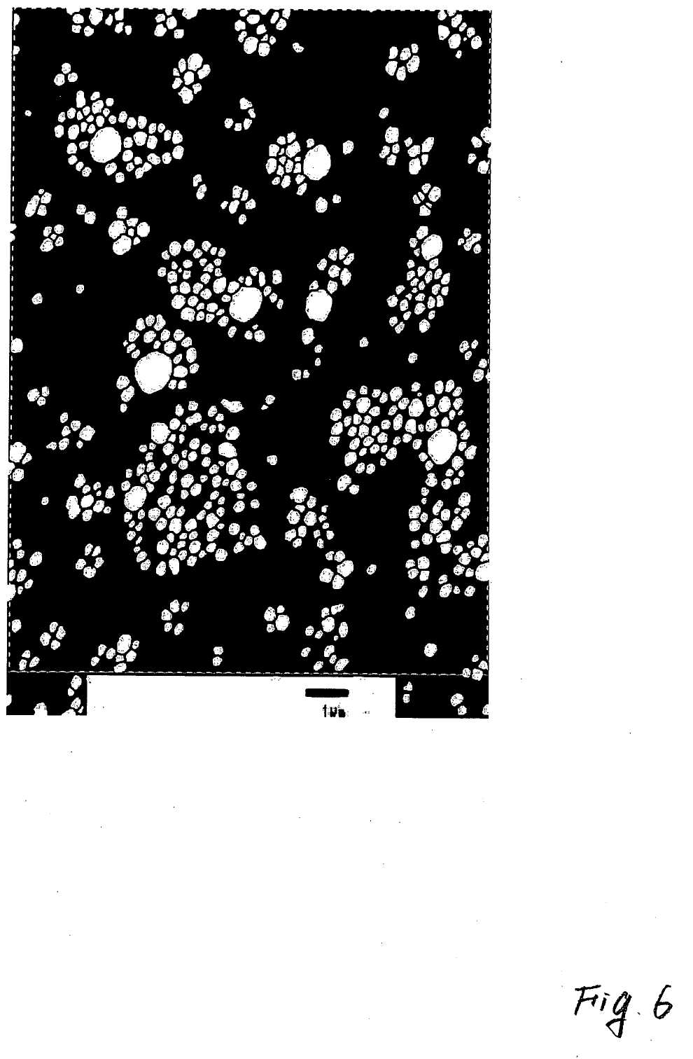

The thus obtained monochrome image file was processed using “Photo Shop” (Ver. 7) available from Adobe Inc., to extract an information of the rubber particles and convert it into binary data, thereby preparing an image for measurement (refer to the attached FIG. 3 or FIG. 6). The extraction of the rubber particles and the conversion into binary data were conducted based on the following standards. (1) The dark-color non-continuous phase (C) observed as a result of the above two-stage dyeing was extracted as the “rubber particles”. Upon the extraction, the light-color domains (B) present inside of the dark-color non-continuous phase (C) were involved in the occupation area of the “rubber particles”. (2) The threshold value for the conversion into binary data was set to an adequate lightness value at which the dark-color “rubber particles” only were selected, and neither the gray-color matrix (A) lighter than the “rubber particles” nor the light-color domain (B) were selected.

From the thus prepared image for measurement, the occupation area of the rubber particles was measured using “ImagePro Plus” (ver. 4.0) available from Media Cybernetics Inc. Upon the measurement, the length on an image screen was corrected based on the scale recorded upon photographing the respective images. The measurement was performed within the broken line frame as shown in the figures. The thus measured occupation areas of the rubber particles and the number thereof were summed to calculate a number-average value of the occupation areas of the rubber particles, i.e., determine an average occupation area Sg thereof. In this case, the particles having a measured occupation area of not more than 0.01 μm² were excluded from the calculation of the number-average value.

### Examples 1 to 4 and Comparative Examples 1 to 3:

The respective components except for the flame retardant were blended together at the weight ratios shown in Table 1, and mixed with each other using a tumbler for 20 min. Thereafter, the resultant mixture was kneaded using a twin-screw extruder “TEX-30HSST” with a screw diameter of 32 mm and L/D ratio of 42 manufactured by Nippon Seikosho Co., Ltd., at a barrel set temperature of 250° C., a screw set rotating speed of 250 rpm and a set extrusion output of 20 kg/hr. When adding the flame retardant to the mixture, the liquid flame retardant was added at the weight ratio shown in Table 1 and fed into the twin-screw extruder in the course thereof.

The pellets obtained by cutting the extruded strand were dried at 80° C. for 5 hr, and then molded using an injection molding machine “SG-75” manufactured by Sumitomo Jukikai Kogyo Co., Ltd., at a cylinder temperature of 250° C., a mold temperature of 70° C. and a mold cycle of 60 sec, thereby obtaining test pieces of 1A type with and without weld. The respective test pieces were subjected to tensile test to evaluate a weld tensile strength thereof. Further, the pellets obtained in the same manner as above were dried at 80° C. for 5 hr, and then molded using an injection molding machine “SG-75” manufactured by Sumitomo Jukikai Kogyo Co., Ltd., at a cylinder temperature of 300° C., a mold temperature of 70° C. and a mold cycle of 180 sec, thereby obtaining a test piece of 1A type with weld. The thus obtained test piece was subjected to tensile test to evaluate a tensile strength and a weld tensile strength upon retention thereof. The evaluation results of the respective Examples and Comparative Examples are shown in Table 1.

TABLE 1

| | | | | | Comparative | | |
|---|---|---|---|---|---|---|---|
| | Examples | | | | Examples | | |
| Components | 1 | 2 | 3 | 4 | 1 | 2 | 3 |
| (a) PC-1 (wt part) | 70 | 70 | — | 80 | 70 | — | 80 |
| (a) PC-2 (wt part) | — | — | 80 | — | — | 80 | — |
| (b) ABS (Ab = 26 wt %) | 21 | 21 | 14 | 14 | 21 | 14 | 14 |
| (b′) AS-1 (Ab′ = 34 wt %) | 9 | — | 6 | — | — | — | — |
| (wt part) | | | | | | | |
| (b′) AS-2 (Ab′ = 20 wt %) | — | 9 | — | 6 | — | — | — |
| (wt part) | | | | | | | |
| (b′) AS-3 (Ab′ = 26 wt %) | — | — | — | — | 9 | 6 | 6 |
| (wt part) | | | | | | | |
| (c) Flame retardant | — | — | 11 | 15 | — | 11 | 15 |
| (wt part) | | | | | | | |
| (d) PTFE (wt part) | — | — | 0.3 | 0.3 | — | 0.3 | 0.3 |
| (e) Inorganic filler | — | — | — | 5 | — | — | 5 |
| (wt part) | | | | | | | |
| [Formula (1)] | | | | | | | |
| Sd (μm²) | 0.79 | 0.80 | 0.56 | 0.53 | 1.03 | 0.78 | 0.75 |
| Sg (μm²) | 0.05 | 0.05 | 0.05 | 0.05 | 0.05 | 0.05 | 0.05 |
| Sg/(Sd/B^{2/3}) (-) | 0.61 | 0.60 | 0.66 | 0.70 | 0.47 | 0.47 | 0.49 |
| [Formula (3)] | | | | | | | |
| \|Ab − Ab′\| (wt %) | 8 | 6 | 8 | 6 | 0 | 0 | 0 |
| [Properties] | | | | | | | |
| Tensile strength (MPa) | 50 | 50 | 58 | 60 | 50 | 62 | 61 |
| Weld tensile strength | 42 | 41 | 28 | 50 | 38 | 27 | 43 |
| (MPa) | | | | | | | |
| Retention rate (%) | 84 | 82 | 48 | 83 | 76 | 44 | 70 |
| Weld tensile strength | 22 | 21 | 26 | 45 | 16 | 20 | 31 |
| upon retention (MPa) | | | | | | | |
| Retention rate (%) | 44 | 42 | 45 | 75 | 32 | 32 | 51 |
| Fluidity (mm) | 190 | 190 | 300 | 220 | 190 | 300 | 220 |

From the above results, it was confirmed that the compositions capable of satisfying the following relational formula (1):

Sg/(Sd/B^{2/3})≧0.5 (1)

wherein B is a weight ratio (% by weight) of a sum of the styrene/(meth)acrylonitrile-based copolymer (b) produced by polymerizing at least the styrene-based monomer and the (meth)acrylonitrile-based monomer with each other in the presence of the rubber and the styrene/(meth)acrylonitrile-based copolymer (b′) produced by polymerizing at least the styrene-based monomer and the (meth)acrylonitrile-based monomer with each other in the absence of the rubber to a sum of the aromatic polycarbonate resin (a) and the components (b) and (b′) ((b+b′)/(a+b+b′)); Sd is an average occupation area of the “AS domain” dispersed in the polycarbonate resin matrix; and Sd is an average occupation area of the rubber particles dispersed in the AS domain in which Sg and Sd are values measured by subjecting an electron micrograph of the composition to image processing, exhibited a high weld strength retention rate.

On the other hand, it was confirmed that the compositions which were incapable of satisfying the relational formula (1) even though they satisfied the requirements as to contents of the respective components (a) to (e) as defined by the present invention, exhibited a poor weld strength retention rate. Further, it was confirmed that the above relational formula (1) was fulfilled by satisfying the following relational formula (3):

|Ab−Ab′|≧3 (3)

wherein Ab is a weight ratio (% by weight) of a (meth)acrylonitrile-based monomer unit to a sum of a styrene-based monomer unit and the (meth)acrylonitrile-based monomer unit in the component (b); and Ab′ is a weight ratio (% by weight) of a (meth)acrylonitrile-based monomer unit to a sum of a styrene-based monomer unit and the (meth)acrylonitrile-based monomer unit in the component (b′).

### [Injection-molded Product]

The pellets obtained in Example 3 and Comparative Example 2 were injection-molded into a box shape having an outer dimension of 150 mm×150 mm×20 mm and a wall thickness of 2 mm using a metal mold with 15 mmΦ four pin gates (coordinates of positions of the respective gates on a plane of 150 mm×150 mm: 25 mm, 75 mm; 75 mm, 25 mm; 75 mm, 125 mm; 125 mm, 75 mm). The molded products obtained in Example 3 all had no problems concerning appearance (inclusive of weld portions thereof), warpage and rigidity. However, the molded products obtained in Comparative Example 2 were deteriorated in appearance, and suffered from breakage at weld portions thereof when applying a force or load thereto.

1. A polycarbonate resin composition comprising:
100 parts by weight of a mixture comprising (a) 60 to 95 parts by weight of an aromatic polycarbonate resin, (b) 4 to 39 parts by weight of a styrene/(meth)acrylonitrile-based copolymer produced by polymerizing at least a styrene-based monomer and a (meth)acrylonitrile-based monomer with each other in the presence of a rubber, and (b′) 1 to 36 parts by weight of a styrene/(meth)acrylonitrile-based copolymer produced by polymerizing at least a styrene-based monomer and a (meth)acrylonitrile-based monomer with each other in the absence of the rubber;
0 to 40 parts by weight of a phosphorus-based flame retardant (c);
0 to 5 parts by weight of a fluorinated polyolefin (d) and
0 to 50 parts by weight of an inorganic filler (e), which (c), (d) and (e) are blended to the 100 parts by weight of the mixture in respective amount,
the polycarbonate resin composition satisfying the following relational formula (1):
Sg/(Sd/B^{2/3})≧0.5 (1)
wherein B is a weight ratio (% by weight) of a sum of the components (b) and (b′) to a sum of the components (a), (b) and (b′) ((b+b′)/(a+b+b′)); Sd is an average occupation area (μm²) of a styrene/(meth)acrylonitrile-based copolymer domain (hereinafter referred to merely as an “AS domain”) dispersed in a polycarbonate resin matrix; and Sg is an average occupation area (pm²) of rubber particles dispersed in the AS domain in which Sd and Sg are values measured by subjecting an electron micrograph of the composition to image processing.

2. A polycarbonate resin composition according to claim 1, wherein the composition satisfies the following relational formula (2):
Sg/(Sd/B^{2/3})≧0.6 (2)
wherein B, Sd and Sg are the same as defined in claim 1.

3. A polycarbonate resin composition according to claim 1, wherein the composition satisfies the following relational formula (3):

|Ab−Ab′|≧3 (3)
wherein Ab is a weight ratio (% by weight) of a (meth)acrylonitrile-based monomer unit to a sum of a styrene-based monomer unit and the (meth)acrylonitrile-based monomer unit in the component (b); and Ab′ is a weight ratio (% by weight) of a (meth)acrylonitrile-based monomer unit to a sum of a styrene-based monomer unit and the (meth)acrylonitrile-based monomer unit in the component (b′).

4. A polycarbonate resin composition according to claim 3, wherein the composition satisfies the following relational formula (4):

|Ab−Ab′|≧5 (4)
wherein Ab and Ab′ are the same as defined in claim 3.

5. A polycarbonate resin composition according to claim 1, wherein the aromatic polycarbonate resin has a viscosity-average molecular weight of 16,000 to 30,000.

6. A polycarbonate resin composition according to claim 1, wherein the phosphorus-based flame retardant is a phosphorus-based compound represented by the following general formula (1) or (2): 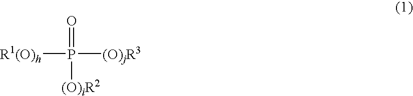
wherein R¹, R² and R³ are respectively an alkyl group having 1 to 6 carbon atoms or an aryl group having 6 to 20 carbon atoms which may be substituted with an alkyl group; and h, i and j are respectively 0 or 1, or 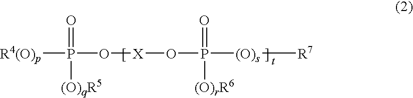
wherein R⁴, R⁵, R⁶ and R⁷ are respectively an alkyl group having 1 to 6 carbon atoms or an aryl group having 6 to 20 carbon atoms which may be substituted with an alkyl group; p, q, r and s are respectively 0 or 1; t is an integer of 1 to 5; and X is an arylene group.

7. A polycarbonate resin composition according to claim 1, wherein the inorganic filler is talc.

8. A molded product obtained by injection-molding the polycarbonate resin composition as defined in claim 1.

9. A molded product according to claim 8, wherein the molded product is an injection-molded product obtained by using a multi-gate molding apparatus.
